(19) United States
(12) Patent Application Publication
(10) Pub. No.: US 2011/0142184 A1
(43) Pub. Date: Jun. 16, 2011

(54) Process and technical arrangement to study nuclear fission by using single atomic layers of nuclear materials with a single crystal structure grown onto undamaged, miniature single crystal hollow body surfaces, which serve as a seeding platform

(76) Inventor: Juergen Wisotzki, Dramstadt (DE)

(21) Appl. No.: 12/801,381

(22) Filed: Oct. 19, 2010

(30) Foreign Application Priority Data
Dec. 11, 2009 (EP) 09015342.0

(51) Int. Cl. G21B 1/00

(52) U.S. Cl. 376/102

(57) ABSTRACT

A new process and arrangement (as shown in FIG. 1) to study nuclear fusion with the aim to achieve a process in which a safer method can be established for the production of electrical power as practiced today in nuclear power plants. The process describes the production of and permits the use of single atomic layers of reactive nuclear materials in a high speed collision which can be brought gradually up in steps to the critical point without any uncontrolled reaction. In the wake of the development it is sought to have a high speed repetitive arrangement which can be used as a low cost and totally safe method of electrical power production, using nuclear materials, without the risk of an uncontrolled reaction or system failure.

### STATE OF THE ART

Fusion research is presently carried out through high speed collision of particles or solid bodies or by driving particles or solid bodies into solid nuclear material. All used materials have a grain structure and as it is known from high speed deformation of a grain structured material, each grain behaves differently to its neighbour grain in the willingness of deformation and alone from that fact, nothing is reliable and can be repeated with the same result a number of times. Furthermore, impurities reside generally in between the grains and form the grain boundaries and all impurities have a different chemical and physical behavior towards the grain structure of the material. As it has been found during the high speed deformation of a grain structured hollow cone in a shaped charge, the lighter elements—which are the impurities—fly first and leave the grains of the grain structure in a lose array, with the tendency to move in to different directions and even with different speed. Coatings deposited on such grain structured materials continue to grow as grain structured coatings and nothing positive can be gained this way.

### BRIEF DESCRIPTION OF THE DRAWINGS

FIG. 1 is a schematic view of the preferred embodiment of the invention before the explosive granules are ignited.

FIG. 2 is a schematic view of the preferred embodiment of the invention after the explosive granules are ignited.

FIG. 3 is a detail view showing the single crystal copper inserts of the preferred embodiment of the invention.

FIG. 4 is a detail view showing the single crystal hollow cones of the preferred embodiment of the invention.

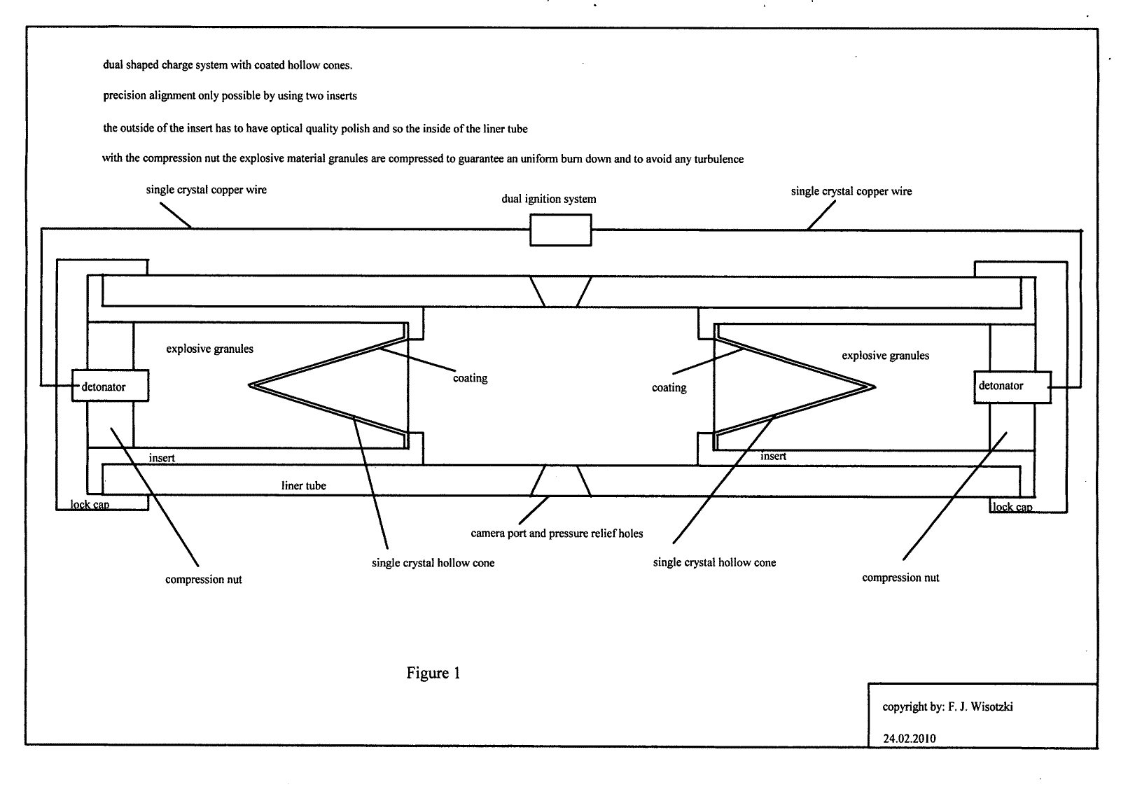

Picture 1 is an X-ray photograph showing the crystal structure of the silver crystal overlaid by the crystal structure of the single crystal copper film in the preferred embodiment of the invention.

Picture 2 shows an X-ray analysis of the deposited film on the glass plate in the preferred embodiment of the invention.

### DETAILED DESCRIPTION OF THE INVENTION

The invention is based on the subsequent research of former developments in the following way, for which patents were granted, such as U.S. Pat. No. 4,896,332 and U.S. Pat. No. 4,949,642.

Single crystal laser mirrors were grown as described in U.S. Pat. No. 4,896,332 and great care was taken to create unharmed, absolute clean, flat optical surfaces, which have the highest purity possible to be obtained in an inert gas atmosphere and an RMS of 1.55 nm. Such surfaces were used as the substrate and coated by sputtering material from sputter targets of different materials of highest purity and without any problems, true crystal growth of the deposited films on those substrates was discovered.

Differences in lattice spacing between the substrate and the oncoming film material lead to the fact, that regardless how big the difference, within a few atomic layers, true crystal structures were found on the film, generally having taken over the crystal orientation of the substrate.

Out of this findings, a European patent application was filed in 1998 which received the number EP 0 997 559 A1, but this patent application was abandoned because of the concern of the inventor that details of the content might lead into a new era of smallest nuclear weapons.

The inventor had disclosed this concern—as thought to be hidden in the application EP 0 997 559 A1—to appropriate institutions in Germany, at the NATO and the United States of America.

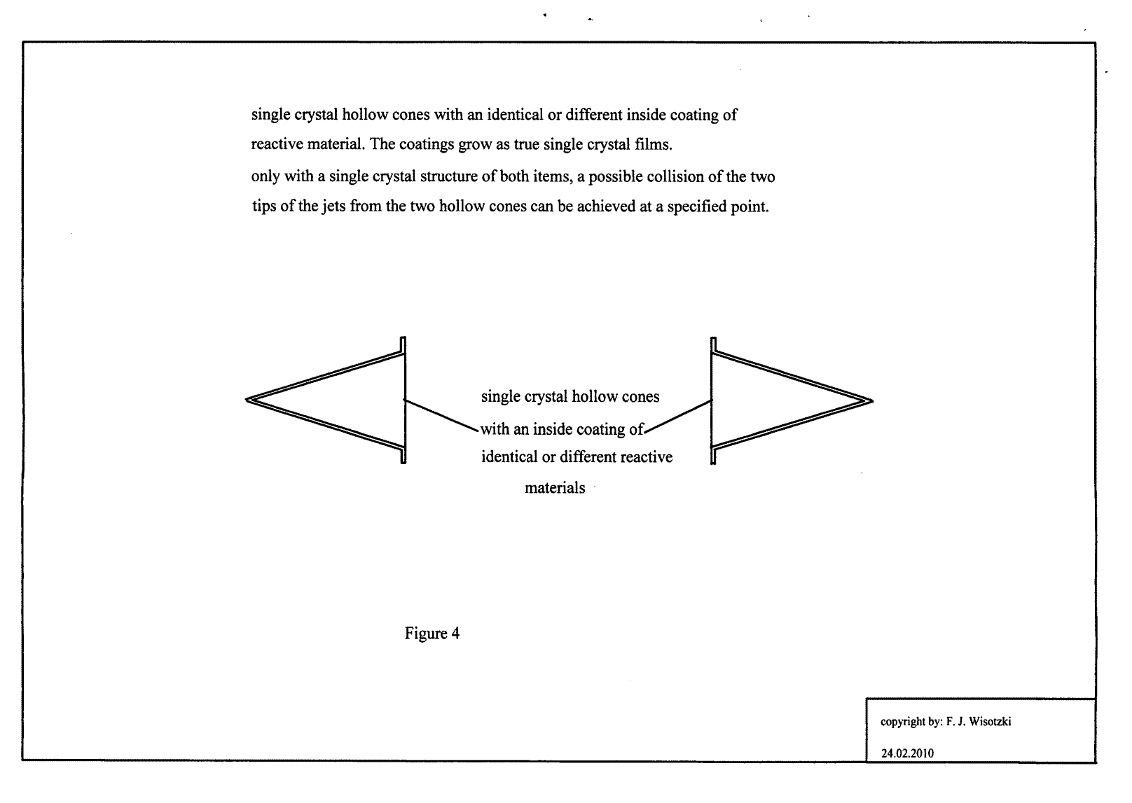

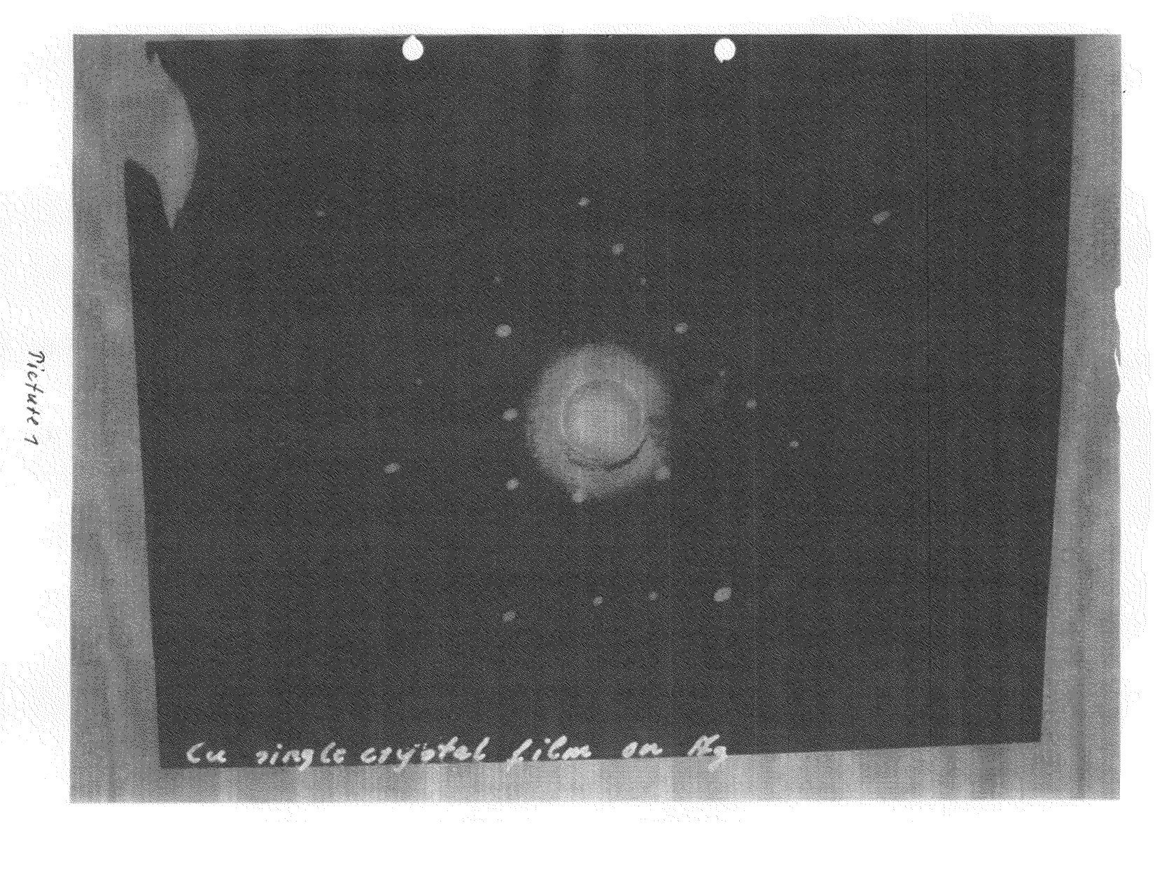

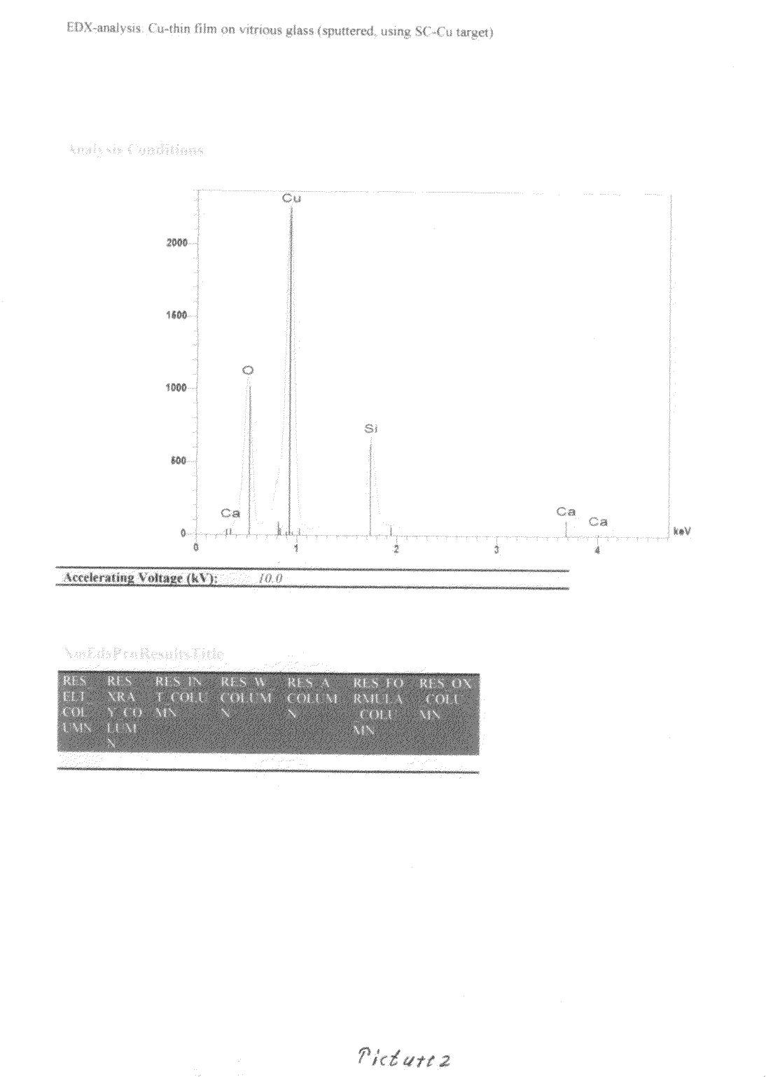

The shaped charge technology using single crystal hollow cones, following the proceedings as described in U.S. Pat. No. 4,949,642 has demonstrated, that the highest possible mechanical accuracy can be achieved. A wall thickness deviation of only 0.5 microns—which is a critical demand in this technology—and surfaces with optical quality of an RMS of 135 nm can only be achieved by growing such hollow cones (FIG. 4) in to the final required form with a true single crystal structure.

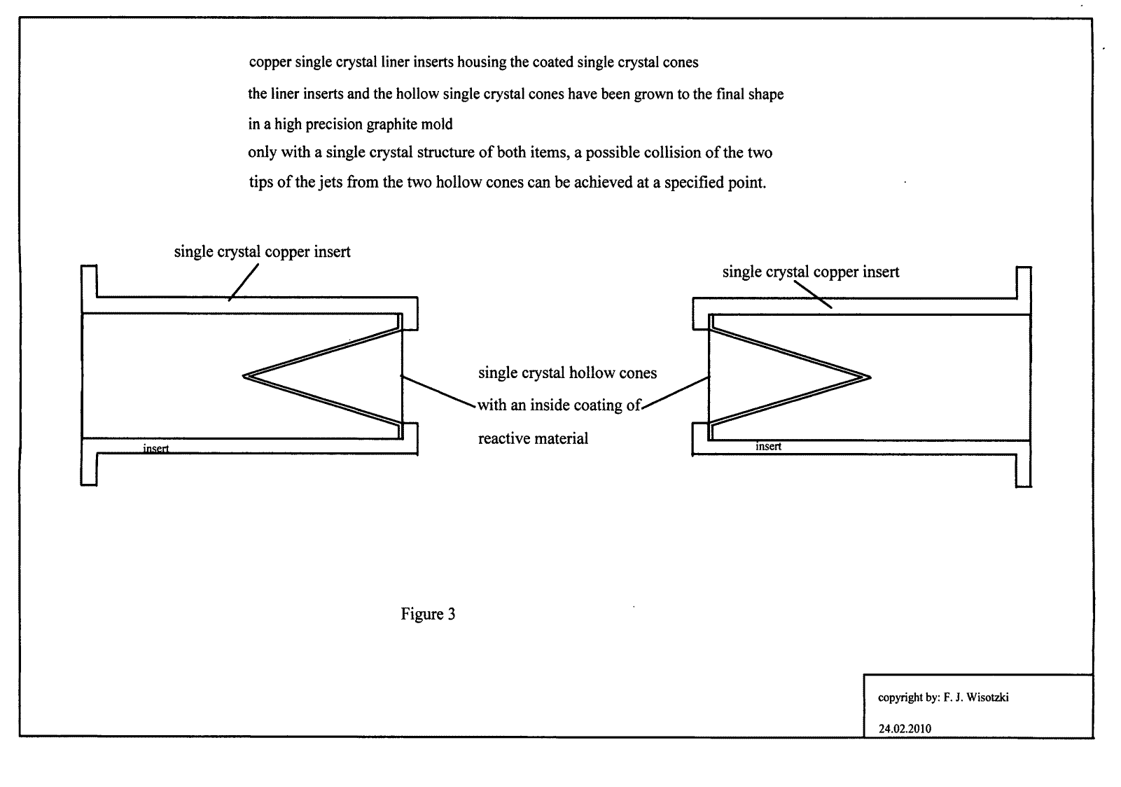

Furthermore, the grown hollow cones and the grown liner inserts (FIG. 3) are totally strain free and do not change their mechanical accuracy by undergoing thermal changes.

The explosive material must be of fine granulate of equal size to avoid any turbulences during burn down, creating a homogenous shock wave for deformation of the single crystal cones into jets.

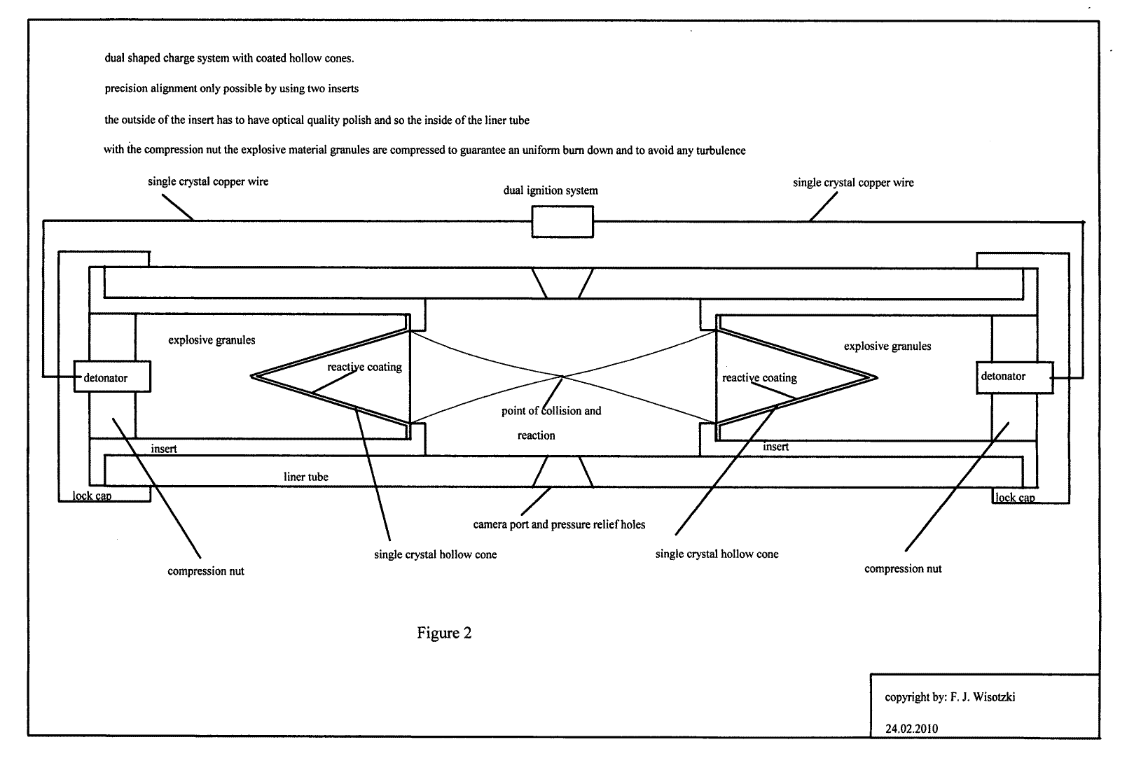

No mechanical machining of such hollow cones or the insert liner, would deliver the required accuracy at the micro-meeting point of the two tips as shown in (FIG. 2).

Depositing the surfaces of such single crystal hollow forms with another metal leads to crystal growth in the deposited material and if required and if both materials do not react to the same solvent, a hollow form of the deposited material remains after the base crystal has been removed chemically.

For the confirmation of this finding of true crystal growth the following study has been undertaken and the result is demonstrated in the attached (picture 1).

Two single crystal bodies were grown, one of high purity silver and one of high purity copper. The silver crystal was used as the substrate onto which the copper film got deposited, being sputtered from the copper crystal which acted as the sputtering target. Half of the silver crystal was covered with a glass plate and the glass plate was therefore partially coated with a copper film as well.

X-ray photographs were taken from the silver crystal and the copper crystal prior to the sputtering and another X-ray photograph was taken of the deposited film. This X-ray photo shows the crystal structure of the silver crystal overlaid by the crystal structure of the single crystal copper film.

To prove that truly copper has been sputtered from the copper target and being deposited as thin film on the silver substrate and on the glass plate as well, an X-ray analysis was taken from the deposited film on the glass plate (picture 2). The main peak in the analysis was Cu which stands for copper and Si and O, beside a few Ca traces. SiO is the glass and the Ca traces are impurities in the glass.

Through this arrangement, there are now many variable options available for fusion research, because they can be manipulated to requirements in the following way:
a) the tip size of each jet from each cone, from large diameters down to 1.0 mm
b) the shape of the tip of each jet from each cone by changing the configuration of the apex of each cone
c) the thickness of the deposited film of the reactive materials on each cone and the quality and force of the explosive material which alters the speed of each tip of the jet of the cones.

Minimum speeds of two times 12 km per second can be achieved at the meeting point of the two micro-tips and varied to requirements, leading to a fusion reaction with highly enriched materials.

Further, a variety of so far unused materials in this field of technology may be investigated through this way.

1. A device, comprising:
two single crystal hollow cones, grown to a final form from a reactive material, embedded in explosive material, with such an accuracy, that micro-tips can meet at a specific collision point to create a reaction.

2. A device comprising:
two single crystal cones, coated with a reactive material in such a way, that the reactive material is a surface on both tips at a meeting point.

3. A device comprising:
a first single crystal hollow cone and a second single crystal hollow cone, [[where]] wherein each cone has a different form to create at a meeting point one sharp tip from the first cone and from the second cone a larger round tip.

4. A device, comprising:
two single crystal cones, wherein each cone is made of a different reactive material.

5. A device comprising:
two single crystal hollow cones and explosive materials with a different power of the explosive material to vary a meeting point of two tips from the hollow cones.

6. A device comprising:
two single crystal cones wherein a meeting point of the two tips from the hollow cones can be varied in its position by delaying one explosion electronically from a joint ignition box.

7. A single crystal target comprising:
a few atomic layers of a reactive material in shapes selected from the group comprising flat, square, rectangular, circular, and curved, mounted between two tips in such a way, that one tip hits the target first, followed by the second tip with a minor delay.

8. A device according to claim 2, wherein each cone is made of a different reactive material.
